(19) United States
(12) Patent Application Publication
(10) Pub. No.: US 2021/0311915 A1
(43) Pub. Date: Oct. 7, 2021

(54) METHODS AND SYSTEMS FOR EXTRACTING DOCUMENT ELEMENTS FOR USE IN GENERATING AND POPULATING MESSAGE TEMPLATES

(71) Applicant: Litmus Software, Inc., Cambridge, MA (US)

(72) Inventors: Edward Joseph Cianci, New Boston, NH (US); Matthew Gore, Needham, MA (US); Jordan Peter MacDonald, Sudbury (CA)

(21) Appl. No.: 17/222,404

(22) Filed: Apr. 5, 2021

Related U.S. Application Data
(60) Provisional application No. 63/006,004, filed on Apr. 6, 2020.

(51) Int. Cl. G06F 16/21; G06F 16/957

(52) U.S. Cl. CPC G06F 16/212; G06F 16/9577

(57) ABSTRACT

A method for extracting document elements for use in generating and populating message templates includes importing, by an analysis engine executing on a computing device, a first document including computer code. The analysis engine generates a hierarchical data structure including the computer code and identifies at least one candidate element of the hierarchical data structure for extraction. An extraction engine executing on the computing device automatically extracts a first portion of the computer code associated with the at least one candidate. The extraction engine associates the extracted first portion of the computer code and the at least one candidate element with a first template. A template builder receives a request for generation of a second document using the first template. The template builder populates a copy of the first template with the extracted first portion of the computer code and generates the second document from the template.

### CROSS-REFERENCE TO RELATED APPLICATIONS

This application claims priority from U.S. Provisional Patent Application No. 63/006,004, filed on Apr. 6, 2020, entitled “Methods and Systems for Extracting Document Elements for Use in Generating and Populating Message Templates,” which is hereby incorporated by reference.

### BACKGROUND

The disclosure relates to improving electronic mail (email) message templates. More particularly, the methods and systems described herein relate to functionality for extracting document elements for use in generating and populating message templates.

Conventional systems allow users to generate templates that can be automatically populated with data and sent as emails to recipients viewing the emails through a variety of email applications. However, upon creation of such an email, conventional systems do not typically provide functionality for automated re-use of elements of the email in the templates. There is a need for functionality that identifies portions of emails for re-use and automatically extracts the underlying code to enable re-use in message templates.

### BRIEF SUMMARY

In one aspect, a method for extracting document elements for use in generating and populating message templates includes importing, by an analysis engine executing on a computing device, a first document including computer code. The method includes generating, by the analysis engine, a hierarchical data structure including the computer code. The method includes identifying, by the analysis engine, at least one candidate element of the hierarchical data structure for extraction. The method includes determining, by an extraction engine executing on the computing device, to extract the at least one candidate element. The method includes automatically extracting, by the extraction engine, a first portion of the computer code associated with the at least one candidate. The method includes storing, by the extraction engine, the extracted first portion of the computer code. The method includes associating, by the extraction engine, the extracted first portion of the computer code and the at least one candidate element with a first template. The method includes receiving, by a template builder executing on the computing device, a request for generation of a second document using the first template. The method includes populating, by the template builder, a copy of the first template with the extracted first portion of the computer code. The method includes generating, by the template builder, the second document from the populated copy of the first template.

In another aspect, a method for extracting document elements for use in generating and populating message templates includes importing, by an analysis engine executing on a computing device, a first document including computer code. The method includes generating, by the analysis engine, a hierarchical data structure including the computer code. The method includes identifying, by the analysis engine, at least one candidate element of the hierarchical data structure for extraction. The method includes generating, by an extraction engine, a user interface displaying a visual rendering of the computer code associated with the at least one candidate element. The method includes receiving, by the extraction engine, user interface input requesting extraction of the at least one candidate element. The method includes extracting, by the extraction engine, a first portion of the computer code associated with the at least one candidate. The method includes storing, by the extraction engine, the extracted first portion of the computer code. The method includes associating, by the extraction engine, the extracted first portion of the computer code and the at least one candidate element with a template. The method includes receiving, by a template builder, a request for generation of a second document using the template. The method includes populating, by the template builder, a copy of the template with the extracted first portion of the computer code. The method includes generating, by the template builder, the second document from the populated copy of the template.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for extracting document elements for use in generating and populating message templates;

FIG. 1B is a block diagram depicting an embodiment of a system for extracting document elements for use in generating and populating message templates;

FIG. 1C is a block diagram depicting one embodiment of a user interface for populating an email template;

FIG. 2 is a flow diagram depicting an embodiment of a method for extracting document elements for use in generating and populating message templates;

FIG. 3 is a flow diagram depicting an embodiment of a method for extracting document elements for use in generating and populating message templates; and

FIGS. 4A-4C are block diagrams depicting embodiments of computers useful in connection with the methods and systems described herein.

### DETAILED DESCRIPTION

The present disclosure relates to methods and systems for extracting document elements for use in generating and populating message templates. The methods and systems described herein may provide functionality for decomposing documents into separate elements and for re-using the decomposed component parts in the creation of subsequent documents. As an example, the systems and methods described herein may include functionality for importing a previously composed email, disassembling the email into portions, saving at least one of portions of the computer code underlying the disassembled portions of the email, associating the saved portions of the computer code with at least one template, and storing the saved portions for later re-use in generating subsequent email using the at least one template. By extracting the computer code (including, e.g., HyperText Markup Language and Cascading Style Sheets) and storing the components of the code for later re-use, the systems and methods described herein improve processes for automated or partially-automated generation of documents. The systems and methods described herein may include functionality for allowing users to drag and drop visual representations of document elements into new documents and then taking the action of finding previously extracted code associated with the visual representations and using the extracted code in generation of new documents, providing an improved system for automated or partially-automated document generation.

In some embodiments, the methods and systems described herein may provide functionality for determining that certain portions of a document accomplish certain goals of the document's author more or less effectively than other portions and may use that determination in determining whether or not to make the code underlying those portions of the document available for re-use.

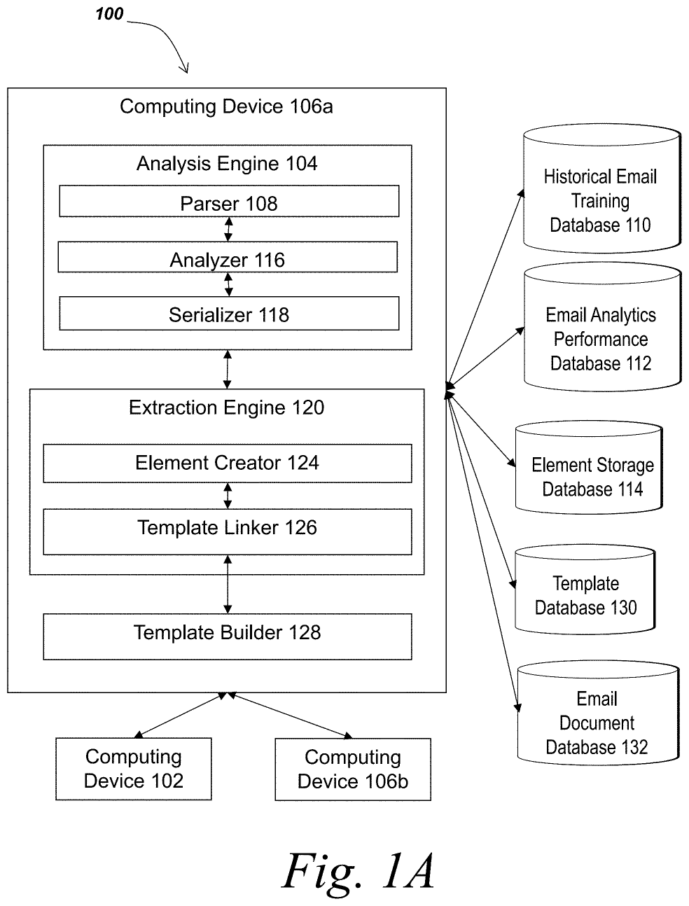

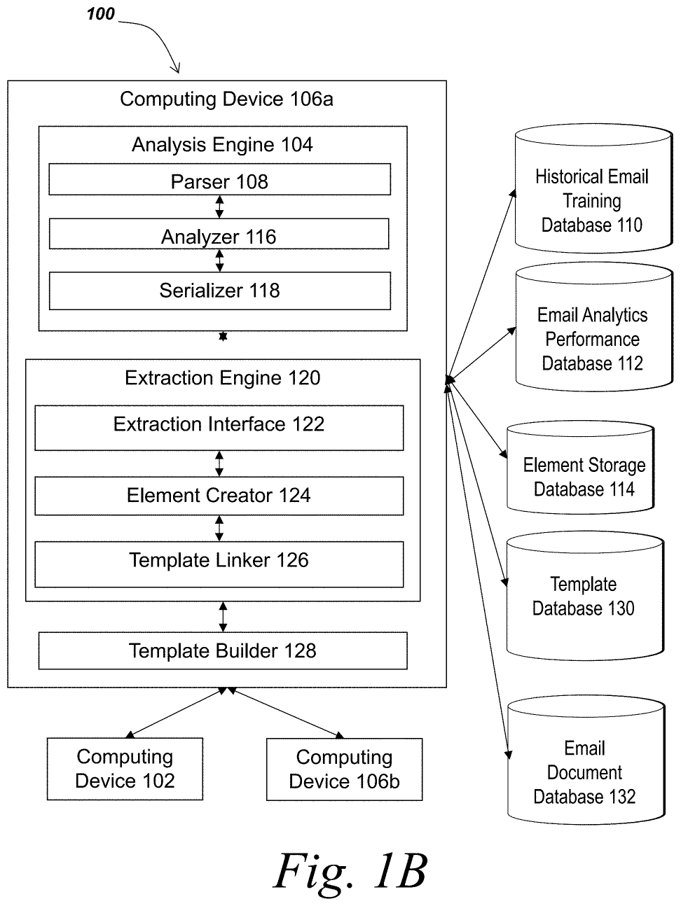

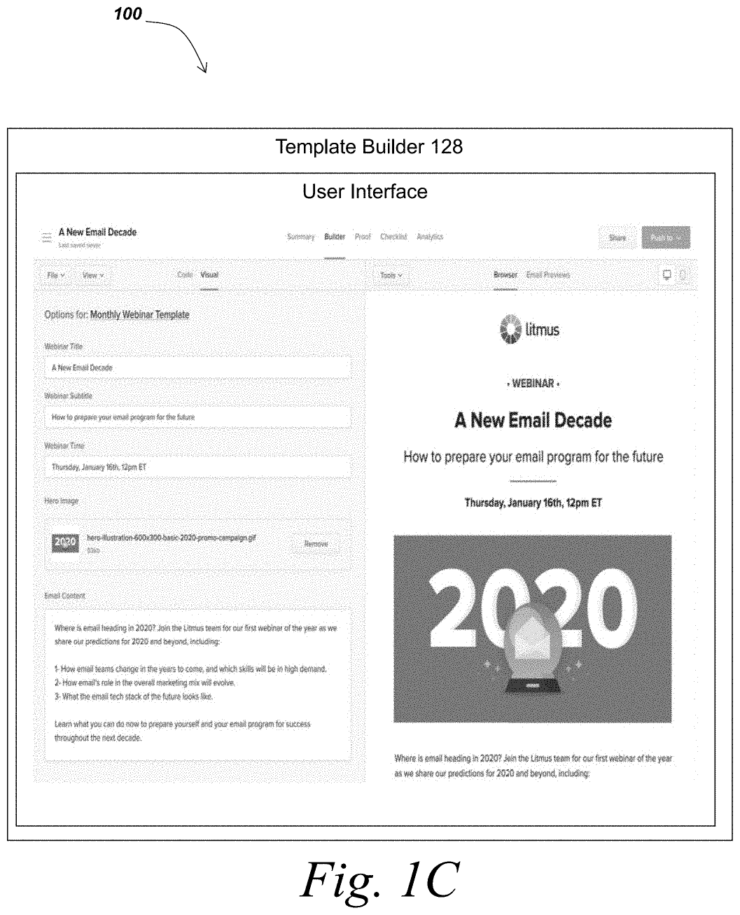

Referring now to FIG. 1A, a block diagram depicts one embodiment of a system 100 for extracting document elements for use in generating and populating message templates. The system 100 includes a first computing device 106a, a second computing device 102, a third computing device 106b, an analysis engine 104, a parser 108, a historical email training database 110, an email analytics performance database 112, an element storage database 114, an analyzer 116, a serializer 118, an extraction engine 120, an element creator 124, a template linker 126, a template builder 128, a template database 130, and an email document database 132.

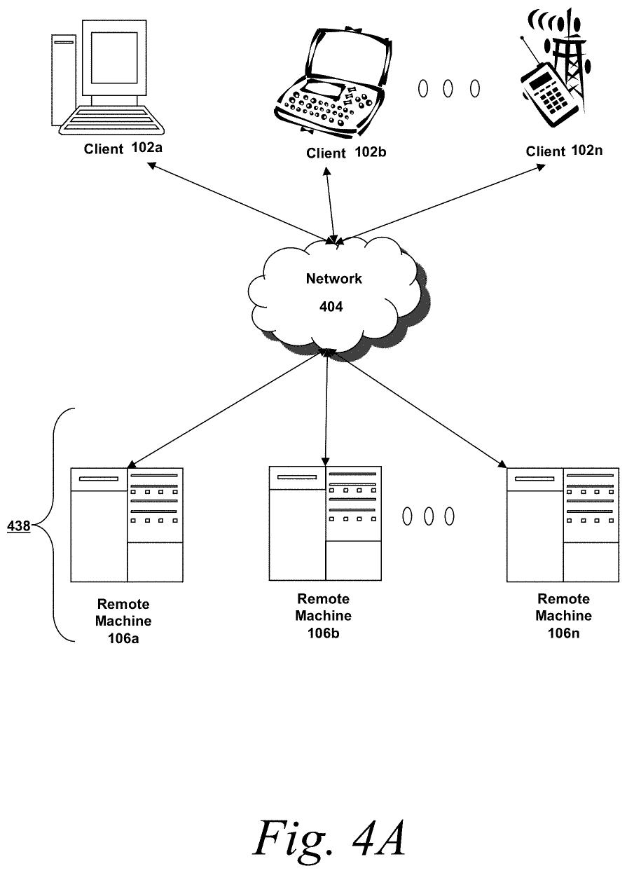

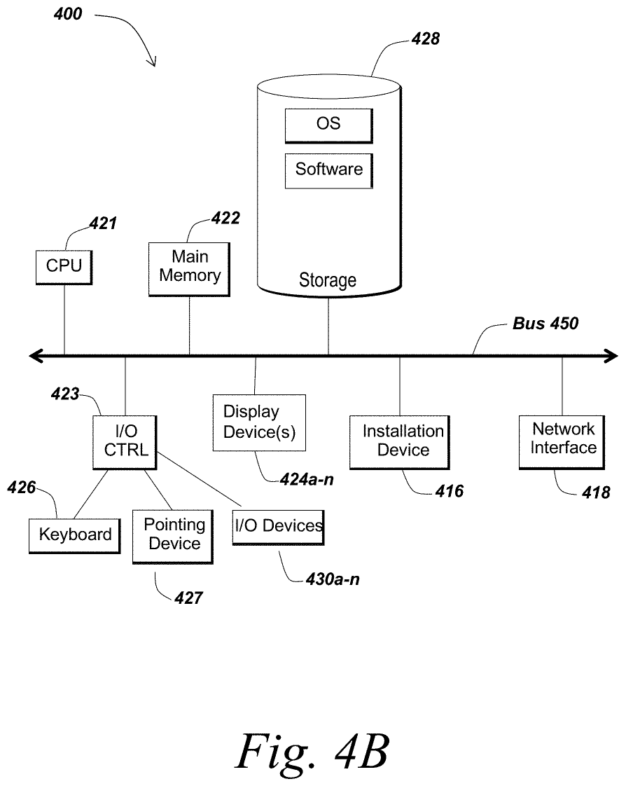

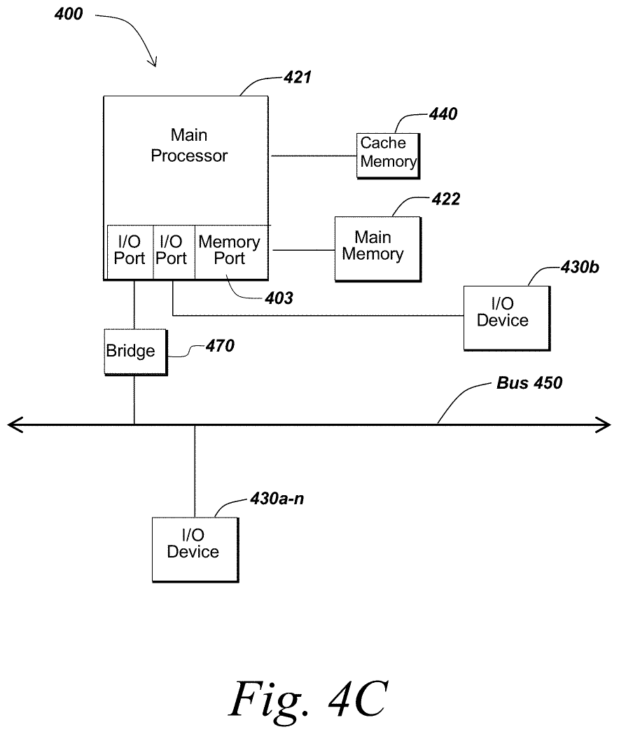

In some embodiments, the computing device 106a is a machine as described below in connection with FIGS. 4A-4C that has been modified to execute the analysis engine 104 and the extraction engine 120 in order to provide the functionality described herein and solve the technical problem of how to automatically identify computer code underlying one or more electronic mail (email) messages for re-use in automatic population of templates for subsequent email messages, and extracting that identified code and making it accessible when populating messages generated via the email templates.

In one embodiment, the analysis engine 104 is a software program. In another embodiment, the analysis engine 104 is a hardware module. The computing device 106a may execute the analysis engine 104. The analysis engine 104 may be in communication with the historical email training database 110. The analysis engine 104 may be in communication with the email analytics performance database 112.

In one embodiment, the parser 108 is a software program. In another embodiment, the parser 108 is a hardware module. The analysis engine 104 may execute the parser 108. The analysis engine 104 may be in communication with the parser 108. The parser 108 may be in communication with the historical email training database 110.

In one embodiment, the analyzer 116 is a software program. In another embodiment, the analyzer 116 is a hardware module. The analysis engine 104 may execute the analyzer 116. The analysis engine 104 may be in communication with the analyzer 116.

In one embodiment, the serializer 118 is a software program. In another embodiment, the serializer 118 is a hardware module. The analysis engine 104 may execute the serializer 118. The analysis engine 104 may be in communication with the serializer 118.

In one embodiment, the extraction engine 120 is a software program. In another embodiment, the extraction engine 120 is a hardware module. The computing device 106a may execute the extraction engine 120. The extraction engine 120 may be in communication with the element storage database 114. The extraction engine 120 may be in communication with the template database 130.

Referring ahead to FIG. 1B, in some embodiments and as depicted in FIG. 1B, the system 100 may include an extraction interface 122. The computing device 106a may execute the extraction interface 122. The extraction engine 120 may execute the extraction interface 122. The extraction interface 122 may be provided as a software program. The extraction interface 122 may be provided as a hardware module. The extraction interface 122 may generate a user interface for display by the computing device 102 to a user of the system 100.

Referring back to FIG. 1A, in one embodiment, the element creator 124 is a software program. In another embodiment, the element creator 124 is a hardware module. The extraction engine 120 may execute the element creator 124. The extraction engine 120 may be in communication with the element creator 124.

In one embodiment, the template linker 126 is a software program. In another embodiment, the template linker 126 is a hardware module. The extraction engine 124 may execute the template linker 124. The extraction engine 124 may be in communication with the template linker 124.

In one embodiment, the template builder 128 is a software program. In another embodiment, the template builder 128 is a hardware module. The computing device 106a may execute with the template builder 128. The template builder 128 may include or be in communication with the template database 130. The template builder 128 may include or be in communication with the email document database 132.

In some embodiments, the databases 110, 112, 114, 128, 130, and 132 may each be provided as an ODBC-compliant database. For example, the databases may be provided as an ORACLE database, manufactured by Oracle Corporation of Redwood Shores, Calif. In other embodiments, the databases may be Microsoft ACCESS databases or Microsoft SQL server databases, manufactured by Microsoft Corporation of Redmond, Wash. In other embodiments, the databases may be SQLite databases, distributed by Hwaci of Charlotte, N.C., or PostgreSQL databases distributed by The PostgreSQL Global Development Group. In still other embodiments, the databases may be custom-designed databases based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), H Base databases distributed by The Apache Software Foundation of Forest Hill, Md., MongoDB databases distributed by 10Gen, Inc., of New York, N.Y., an AWS DynamoDB distributed by Amazon Web Services and Cassandra databases distributed by The Apache Software Foundation of Forest Hill, Md. In further embodiments, the databases may be any form or type of database.

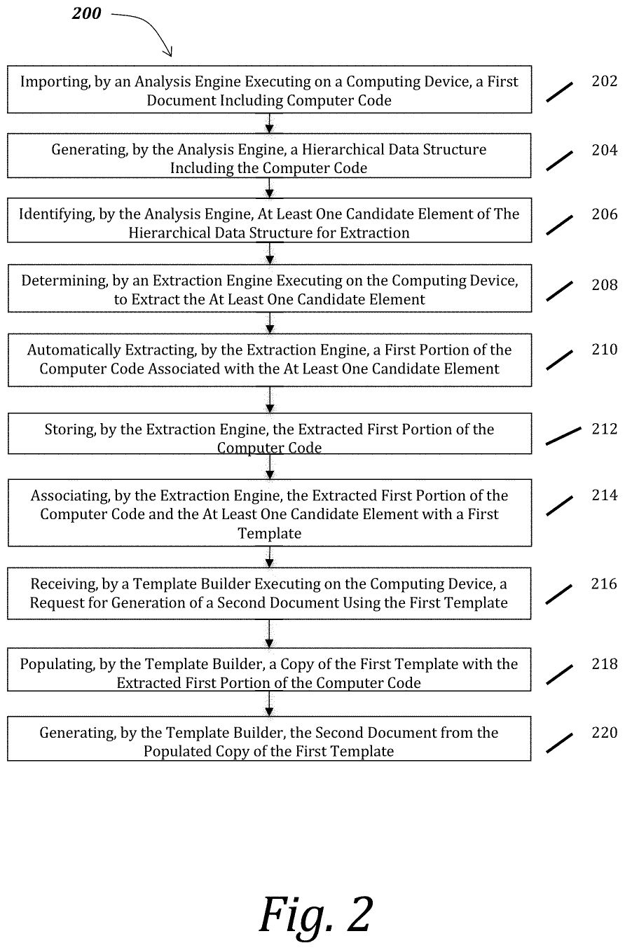

Referring now to FIG. 2, a flow diagram depicts one embodiment of a method 200 for extracting document elements for use in generating and populating message templates. In brief overview, the method 200 includes importing, by an analysis engine executing on a computing device, a first document including computer code (202). The method 200 includes generating, by the analysis engine, a hierarchical data structure including the computer code (204). The method 200 includes identifying, by the analysis engine, at least one candidate element of the hierarchical data structure for extraction (206). The method 200 includes determining, by an extraction engine executing on the computing device, to extract the at least one candidate element (208). The method 200 includes automatically extracting, by the extraction engine, a first portion of the computer code associated with the at least one candidate (210). The method 200 includes storing, by the extraction engine, the extracted first portion of the computer code (212). The method 200 includes associating, by the extraction engine, the extracted first portion of the computer code and the at least one candidate element with a first template (214). The method 200 includes receiving, by a template builder executing on the computing device, a request for generation of a second document using the first template (216). The method 200 includes populating, by the template builder, a copy of the first template with the extracted first portion of the computer code (218). The method 200 includes generating, by the template builder, the second document from the populated copy of the first template (220).

Referring now to FIG. 2 in greater detail and in connection with FIGS. 1A-B, the method 200 includes importing, by an analysis engine executing on a computing device, a first document including computer code (202). The analysis engine 104 may import a document including computer code that includes HyperText Markup Language (HTML) code. The analysis engine 104 may import a document including computer code that includes Cascading Style Sheets (CSS) code. The analysis engine 104 may import a document including computer code that includes both HTML and CSS code. The analysis engine 104 may import the first document from the historical email training database 110. The analysis engine 104 may receive the first document from a user of the system 100 (e.g., from the computing device 102, via a user interface for importing documents generated by the computing device 106a). The parser 108 may import the first document from the historical email training database 110.

The method 200 includes generating, by the analysis engine, a hierarchical data structure including the computer code (204). The analysis engine 104 may generate the hierarchical data structure by creating a new document and copying a plurality of sections of the computer code into the new document. The analysis engine 104 may generate the hierarchical data structure by copying a plurality of sections of the computer code into an existing hierarchical data structure. The analysis engine 104 may use sections within the computer code to identify a hierarchy of the computer code and populate a new document with the computer code organized into a hierarchy. The analysis engine 104 may apply one or more rules to determine which sections within the computer code to use in populating the new document. The parser 108 may parse the HTML content of the computer code to convert the computer code into a hierarchical data structure.

The method 200 includes identifying, by the analysis engine, at least one candidate element of the hierarchical data structure for extraction (206). The analyzer 116 may analyze the hierarchical data structure to identify the at least one candidate element. The analyzer 116 may identify candidate elements by identifying types of elements (e.g., image or span). The analyzer 116 may identify candidate elements by applying one or more rules. The analyzer 116 may identify candidate elements by identifying a number of descendant elements and applying a rule indicating that elements having a threshold number of descendant elements should be considered for extraction. The analyzer 116 may identify candidate elements by identifying variations of elements within the computer code. The analyzer 116 may apply one or more rules to identify the at least one candidate element. The analyzer 116 may use data retrieved from the email analytics performance database 112 to determine whether the at least one candidate element contributed to the performance of the document for a particular purpose and whether the contribution exceeded a threshold level of contribution to determine whether to include the at least one candidate element; for example, and without limitation, the analyzer 116 may determine that the first document was an email message that contained the at least one candidate element and that the at least one candidate element contributed to the characterization of the email message as successful according to one or more metrics (e.g., level of engagement of the reader with the email message, likelihood of a reader of the email message interacting with the at least one candidate element, likelihood of a reader of the email message taking some action upon viewing the at least one candidate element, etc.).

The serializer 118 may identify an array of positional ranges within the first document associated with each of the at least one candidate elements identified by the analyzer 116. That is, the serializer 118 may receive an identification of the at least one candidate element from the analyzer 116, identify a position of the at least one candidate element within the hierarchical data structure, and then identify a corresponding positional range within the first document to identify where in the first document the computer code that resulted in the element is located. The serializer 118 may organize and tag individual components to allow a user to select elements for inclusion in populating a template.

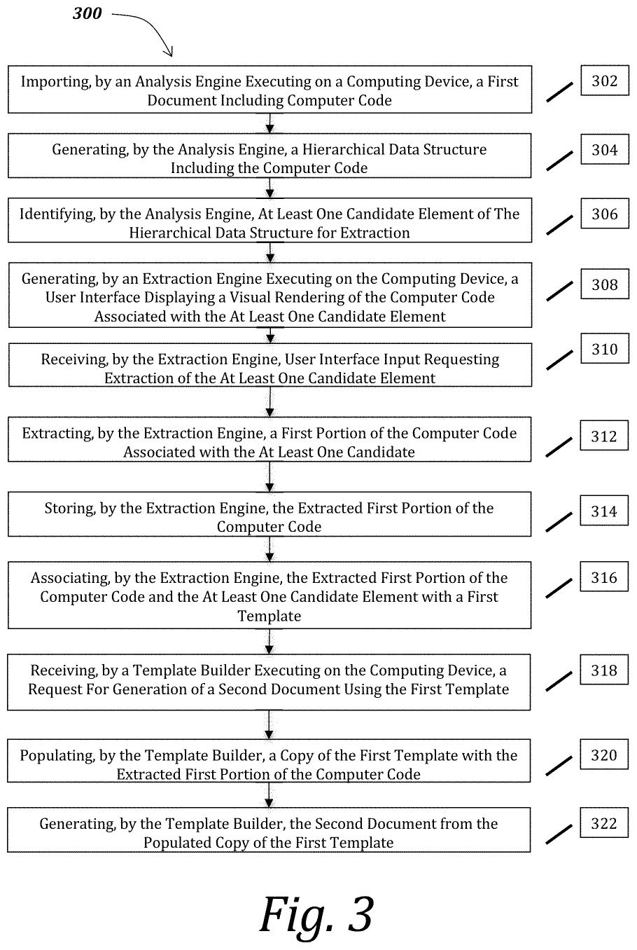

The method 200 includes determining, by an extraction engine executing on the computing device, to extract the at least one candidate element (208). In some embodiments, the extraction engine 120 determines to extract the at least one candidate element without receiving user input to do so. In other embodiments, and as will be discussed in greater detail below in connection with FIG. 3, the extraction engine 120 determines to extract the at least one candidate element upon receiving user input to do so. That is, the serializer 118 may identify positions of one or more candidate elements within hierarchical data structures and within corresponding documents and then tag the individual elements to allow the user to select elements for extraction; upon receiving user input identifying at least one candidate for extraction, the extraction engine 120 may determine to proceed with extraction of the at least one candidate element.

The extraction engine 120 may identify the at least one candidate element by searching for elements stored as reusable elements; for example, and without limitation, the at least one candidate element may have been tagged as a reusable element during the extraction process.

The method 200 includes automatically extracting, by the extraction engine, a first portion of the computer code associated with the at least one candidate element (210). The extraction engine 120 extracts the portion of the computer code associated with the at least one candidate element from the hierarchical data structure (e.g., copies or cuts the portion of the computer code from the hierarchical data structure). In some embodiments, the extraction engine 120 copies a portion of the computer code associated with the at least one candidate element from the first document. The element creator 124 may extract the first portion of the computer code associated with the at least one candidate element.

The method 200 includes storing, by the extraction engine, the extracted first portion of the computer code (212). The extraction engine 120 may store the extracted first portion of the computer code. The element creator 124 may store the extracted first portion of the computer code. The system 100 may store the extracted first portion of the computer code in the element storage database 114.

The method 200 includes associating, by the extraction engine, the extracted first portion of the computer code and the at least one candidate element with a first template (214). The extraction engine 120 may associate the extracted first portion of the computer code and the at least one candidate element with a first template. The template linker 126 may associate the extracted first portion of the computer code and the at least one candidate element with a first template; the first template may be stored in the template database 130.

The method 200 includes receiving, by a template builder executing on the computing device, a request for generation of a second document using the first template (216). The template builder 128 may generate a user interface, such as the user interface depicted in FIG. 1C, which is then displayed to a user of the system, such as a user of the computer 102. The template builder may identify a type of the second document and use the type of the second document to determine that the first template (e.g., a template stored in the template database 130) is associated with the type of the second document. The template builder 128 may then modify the user interface to display the first template. The template builder 128 may modify the user interface to display instructions or other guidance to assist the user with content creation using one or more extracted portions of computer code via the template.

The method 200 includes populating, by the template builder, a copy of the first template with the extracted first portion of the computer code (218). The template builder 128 may receive user-provided content through the user interface generated by the template builder 128 with user-provided instructions to incorporate the content into a second document generated through the use of the first template. The template builder 128 may then interpolate the user-provided content into at least one candidate element and populate a section of the second document in accordance with the first template and the interpolated, user-provided content. The template builder 128 may complete the second document using the template and the interpolated content. The template builder 128 may store the completed second document in the email document database 132. The template builder 128 may make the completed second document available to the user (e.g., the user of the computing device 102) for distribution to one or more other users.

The template builder 128 may receive an instruction to modify the first template and modify the first portion of the computer code in the first template, based on the received instruction.

The template builder 128 may receive an instruction to modify the first template, apply a rule to the received instruction, and determine whether or not to execute the received instruction based upon the application of the rule. In one embodiment, the template builder 128 makes the determination to modify the first portion of the computer code in the first template, based on the application of the rule and the received instruction, and does so. In another embodiment, the template builder 128 makes the determination not to modify the first portion of the computer code in the first template, based on the application of the rule.

In this way, some users (e.g., administrators) may maintain control over how much other users (e.g., non-administrators) are allowed to change the templates. By way of example, an administrative user may determine to only allow certain modifications—allowing users to update documents providing the terms of a sale (e.g., allowing users to change 15% off to a different percentage not to exceed an administrator-specified amount) or the descriptions of the sale (e.g., change “summer sale” to “winter sale”). There may be a “master” element with derivative sub-elements and different sub-elements may have different levels of permission from each other and from the master element. The administrative user may also specify certain rules, such as requiring the application of a spell check by all users before transmitting the document to anyone else, or a restriction based on a level of permission associated with a particular user. The template builder 128 may generate a user interface that reflects one or more rules controlling use of a template. When the template linker 126 links the at least one element to the template, the template linker 126 may specify restrictions as well. By way of example, the ability to edit one or more elements may be limited to elements having a particular location within the hierarchical data structure.

The method 200 includes generating, by the template builder, the second document from the populated copy of the first template (220).

As will be understood by those of ordinary skill in the art, the element creator 124 may associate the same candidate element with multiple different templates and may associate different candidate elements with the same or with different templates. Therefore, in one embodiment, the method includes identifying, by the analysis engine, a second candidate element of the hierarchical data structure for extraction; automatically extracting, by an extraction engine, a second portion of the computer code associated with the second candidate element; storing, by the extraction engine, the second portion of the computer code; associating, by the extraction engine, the second portion of the computer code and the second candidate element with the first template; receiving, by a template builder, a request for generation of a third document using the first template; populating, by the template builder, a copy of the first template with the first portion and the second portion of the computer code; and generating, by the template builder, the third document from the populated copy of the first template. The method may include associating the computer code and the at least one candidate element with a second template. The method may include identifying, by the analysis engine, a second candidate element of the hierarchical data structure for extraction; automatically extracting, by an extraction engine, a second portion of the computer code associated with the second candidate element; storing, by the extraction engine, the second portion of the computer code; associating, by the extraction engine, the second portion of the computer code and the second candidate element with a second template; receiving, by a template builder, a request for generation of a third document using the second template; populating, by the template builder, a copy of the second template with the second portion of the computer code; and generating, by the template builder, the third document from the populated copy of the second template.

In some embodiments, instead of populating a template, the methods and systems described herein may include functionality for executing a visual email builder that allows users to identify one or more candidate elements displayed via a user interface as “modules” that the users can drag and drop to build one or more emails. In such embodiments, users replace default module content by dragging and dropping one or more candidate elements into an email generation user interface (not shown) and replacing copy and other attributes with their own data. In such embodiments, the system may include functionality for storing the completed email in the email document database 132. Therefore, the method 200 may, in some embodiments, include importing, by an analysis engine executing on a computing device, a first document including computer code; generating, by the analysis engine, a hierarchical data structure including the computer code; identifying, by the analysis engine, at least one candidate element of the hierarchical data structure for extraction; generating, by an extraction engine executing on the computing device, a user interface displaying a visual rendering of the computer code associated with the at least one candidate element; receiving, by the extraction engine, user interface input requesting extraction of the at least one candidate element; extracting, by the extraction engine, a first portion of the computer code associated with the at least one candidate; storing, by the extraction engine, the extracted first portion of the computer code; associating, by the extraction engine, the extracted first portion of the computer code and the at least one candidate element with a first template; receiving, by a template builder executing on the computing device, a request for generation of a second document using the first template; displaying, by a visual email builder an enumeration of one or more candidate elements available for re-use; receiving, by the visual email builder, an identification of at least one of the enumerated one or more candidate elements; and generating, by the visual email builder, a second document from the identified at least one of the enumerated one or more candidate elements.

Referring now to FIG. 3, a flow diagram depicts one embodiment of a method 300 for extracting document elements for use in generating and populating message templates. In brief overview, the method 300 includes importing, by an analysis engine executing on a computing device, a first document including computer code (302). The method 300 includes generating, by the analysis engine, a hierarchical data structure including the computer code (304). The method 300 includes identifying, by the analysis engine, at least one candidate element of the hierarchical data structure for extraction (306). The method 300 includes generating, by an extraction engine executing on the computing device, a user interface displaying a visual rendering of the computer code associated with the at least one candidate element (308). The method 300 includes receiving, by the extraction engine, user interface input requesting extraction of the at least one candidate element (310). The method 300 includes extracting, by the extraction engine, a first portion of the computer code associated with the at least one candidate (312). The method 300 includes storing, by the extraction engine, the extracted first portion of the computer code (314). The method 200 includes associating, by the extraction engine, the extracted first portion of the computer code and the at least one candidate element with a first template (316). The method 300 includes receiving, by a template builder executing on the computing device, a request for generation of a second document using the first template (318). The method 300 includes populating, by the template builder, a copy of the first template with the extracted first portion of the computer code (320). The method 300 includes generating, by the template builder, the second document from the populated copy of the first template (322).

Referring now to FIG. 3, in greater detail and in connection with FIGS. 1A-1C and 2, the method 300 includes importing, by an analysis engine executing on a computing device, a first document including computer code (302). In one embodiment, the importing occurs as described above in connection with FIG. 2, (202).

The method 300 includes generating, by the analysis engine, a hierarchical data structure including the computer code (304). In one embodiment, the generating occurs as described above in connection with FIG. 2, (204).

The method 300 includes identifying, by the analysis engine, at least one candidate element of the hierarchical data structure for extraction (306). In one embodiment, the identifying occurs as described above in connection with FIG. 2, (206).

The method 300 includes generating, by an extraction engine executing on the computing device, a user interface displaying a visual rendering of the computer code associated with the at least one candidate element (308). The extraction interface 122 of FIG. 0 may generate the user interface for display to a user of the computer 102. The extraction interface 122 may use the array of positional ranges generated by the serializer 118 to identify and present the at least one candidate element visually to the user via the user interface. The extraction interface 122 may modify the user interface to visually present a plurality of candidate elements to the user.

The method 300 includes receiving, by the extraction engine, user interface input requesting extraction of the at least one candidate element (310). The extraction interface 122 may receive user input from via the user interface representing a selection of one or more candidate elements for extraction. The extraction interface 122 may transmit an instruction to the element creator 124 to extract the one or more candidate elements selected for extraction.

The method 300 includes extracting, by the extraction engine, a first portion of the computer code associated with the at least one candidate (312). The extraction may occur as described above in connection with FIG. 2, (210).

The method 300 includes storing, by the extraction engine, the extracted first portion of the computer code (314). The storing may occur as described above in connection with FIG. 2, (212).

The method 300 includes associating, by the extraction engine, the extracted first portion of the computer code and the at least one candidate element with a first template (316). The associating may occur as described above in connection with FIG. 2, (214).

The method 300 includes receiving, by a template builder executing on the computing device, a request for generation of a second document using the first template (318). The receiving may occur as described above in connection with FIG. 2, (216).

The method 300 includes populating, by the template builder, a copy of the first template with the extracted first portion of the computer code (320). The populating may occur as described above in connection with FIG. 2, (218).

The method 300 includes generating, by the template builder, the second document from the populated copy of the first template (322). The storing may occur as described above in connection with FIG. 2, (220).

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure, possibly in combination with other embodiments of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PYTHON, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 4A, 4B, and 4C, block diagrams depict additional detail regarding computing devices that may be modified to execution functionality for implementing the methods and systems described above.

Referring now to FIG. 4A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 404.

Although FIG. 4A shows a network 404 between the client(s) 102 and the remote machines 106, the client(s) 102 and the remote machines 106 may be on the same network 404. The network 404 can be a local area network (LAN), such as a company Intranet, a metropolitan area network (MAN), or a wide area network (WAN), such as the Internet or the World Wide Web. In some embodiments, there are multiple networks 404 between the client(s) and the remote machines 106. In one of these embodiments, a network 404′ (not shown) may be a private network and a network 404 may be a public network. In another of these embodiments, a network 404 may be a private network and a network 404′ a public network. In still another embodiment, networks 404 and 404′ may both be private networks. In yet another embodiment, networks 404 and 404′ may both be public networks.

The network 404 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network 404 may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client(s) 102 and a remote machine 106 (referred to generally as computing devices 400) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client(s) 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client(s) 102.

In one embodiment, a computing device 106 provides functionality of a web server. In some embodiments, a web server 106 comprises an open-source web server, such as the NGINX web servers provided by NGINX, Inc., of San Francisco, Calif., or the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 438. In another of these embodiments, the server farm 438 may be administered as a single entity.

FIGS. 4B and 4C depict block diagrams of a computing device 100 useful for practicing an embodiment of the client(s) 102 or a remote machine 106. As shown in FIGS. 4B and 4C, each computing device 100 includes a central processing unit 421, and a main memory unit 422. As shown in FIG. 4B, a computing device 400 may include a storage device 428, an installation device 416, a network interface 418, an I/O controller 423, display devices 424a-n, a keyboard 426, a pointing device 427, such as a mouse, and one or more other I/O devices 430a-n. The storage device 428 may include, without limitation, an operating system and software. As shown in FIG. 4C, each computing device 400 may also include additional optional elements, such as a memory port 403, a bridge 470, one or more input/output devices 430a-n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 400 may be based on any of these processors, or any other processor capable of operating as described herein.

Main memory unit 422 may be one or more memory chips capable of storing data and allowing any storage location to be directly accessed by the microprocessor 421. The main memory 422 may be based on any available memory chips capable of operating as described herein. In the embodiment shown in FIG. 4B, the processor 421 communicates with main memory 422 via a system bus 450. FIG. 4C depicts an embodiment of a computing device 400 in which the processor communicates directly with main memory 422 via a memory port 403. FIG. 4C also depicts an embodiment in which the main processor 321 communicates directly with cache memory 440 via a secondary bus, sometimes referred to as a backside bus. In other embodiments, the main processor 421 communicates with cache memory 440 using the system bus 450.

In the embodiment shown in FIG. 4B, the processor 421 communicates with various I/O devices 430 via a local system bus 450. Various buses may be used to connect the central processing unit 421 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computer 400 in which the main processor 421 also communicates directly with an I/O device 430b via, for example, HYPERTRANSPORT, RAPIDIO, or INFINIBAND communications technology.

One or more of a wide variety of I/O devices 430a-n may be present in or connected to the computing device 400, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 423 as shown in FIG. 4B. Furthermore, an I/O device may also provide storage and/or an installation medium 416 for the computing device 400. In some embodiments, the computing device 400 may provide USB connections (not shown) to receive handheld USB storage devices such as the USB Flash Drive line of devices manufactured by Twintech Industry, Inc. of Los Alamitos, Calif.

Referring still to FIG. 4B, the computing device 400 may support any suitable installation device 416, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 400 may provide functionality for installing software over a network 404. The computing device 400 may further comprise a storage device, such as one or more hard disk drives or redundant arrays of independent disks, for storing an operating system and other software. Alternatively, the computing device 400 may rely on memory chips for storage instead of hard disks.

Furthermore, the computing device 400 may include a network interface 418 to interface to the network 404 through a variety of connections including, but not limited to, standard telephone lines, LAN or WAN links (e.g., 802.11, Ti, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 400 communicates with other computing devices 400′ via any type and/or form of gateway or tunneling protocol such as Secure Socket Layer (SSL) or Transport Layer Security (TLS). The network interface 418 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In further embodiments, an I/O device 430 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 400 of the sort depicted in FIGS. 4B and 4C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.1-4.0, WINDOWS CE, WINDOWS XP, WINDOWS 7, WINDOWS 8, WINDOWS VISTA, and WINDOWS 10, all of which are manufactured by Microsoft Corporation of Redmond, Wash.; any version of MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

The computing device 400 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 400 is a mobile device, such as a JAVA-enabled cellular telephone/smartphone or personal digital assistant (PDA). The computing device 400 may be a mobile device such as those manufactured, by way of example and without limitation, by Apple Inc. of Cupertino, Calif.; Google/Motorola Div. of Ft. Worth, Tex.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smartphone, POCKET PC, POCKET PC PHONE, or other portable mobile device supporting Microsoft Windows Mobile Software.

In some embodiments, the computing device 400 is a digital audio player. In one of these embodiments, the computing device 400 is a digital audio player such as the Apple IPOD, IPOD TOUCH, IPOD NANO, and IPOD SHUFFLE lines of devices manufactured by Apple Inc. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J., or Creative Technologies Ltd. of Singapore. In yet other embodiments, the computing device 400 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 400 comprises a combination of devices, such as a mobile phone combined with a digital audio player or portable media player. In one of these embodiments, the computing device 100 is a device in the Google/Motorola line of combination digital audio players and mobile phones. In another of these embodiments, the computing device 400 is a device in the IPHONE smartphone line of devices manufactured by Apple Inc. In still another of these embodiments, the computing device 400 is a device executing the ANDROID open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 400 is a tablet device such as, for example and without limitation, the IPAD line of devices manufactured by Apple Inc.; the PLAYBOOK manufactured by Research In Motion; the CRUZ line of devices manufactured by Velocity Micro, Inc. of Richmond, Va.; the FOLIO and THRIVE line of devices manufactured by Toshiba America Information Systems, Inc. of Irvine, Calif.; the GALAXY line of devices manufactured by Samsung; the HP SLATE line of devices manufactured by Hewlett-Packard; and the STREAK line of devices manufactured by Dell, Inc. of Round Rock, Tex.

Having described certain embodiments of methods and systems for extracting document elements for use in generating and populating message templates, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for extracting document elements for use in generating and populating a message template, the method comprising:
importing, by an analysis engine executing on a computing device, a first document including computer code;
generating, by the analysis engine, a hierarchical data structure including the computer code;
identifying, by the analysis engine, at least one candidate element of the hierarchical data structure for extraction;
determining, by an extraction engine executing on the computing device, to extract the at least one candidate element;
automatically extracting, by the extraction engine, a first portion of the computer code associated with the at least one candidate element;
storing, by the extraction engine, the extracted first portion of the computer code;
associating, by the extraction engine, the extracted first portion of the computer code and the at least one candidate element with a first template;
receiving, by a template builder executing on the computing device, a request for generation of a second document using the first template;
populating, by the template builder, a copy of the first template with the extracted first portion of the computer code; and
generating, by the template builder, the second document from the populated copy of the first template.

2. The method of claim 1, wherein importing further comprises importing a first document including computer code, wherein the computer code includes HyperText Markup Language (HTML) code.

3. The method of claim 1, wherein importing further comprises importing a first document including computer code, wherein the computer code includes Cascading Style Sheets (CSS) code.

4. The method of claim 1, wherein importing further comprises importing a first document including computer code, wherein the computer code includes HTML code and CSS code.

5. The method of claim 1, wherein generating further comprises copying a plurality of sections of the computer code into the hierarchical data structure.

6. The method of claim 1 further comprising:
receiving, by the template builder, an instruction to modify the first template; and
modifying, by the template builder, the first portion of the computer code in the first template based on the received instruction.

7. The method of claim 1 further comprising:
receiving, by the template builder, an instruction to modify the first template;
applying, by the template builder, a rule to the received instruction; and
determining, by the template builder, whether or not to execute the received instruction based upon the application of the rule.

8. The method of claim 7 further comprising modifying, by the template builder, the first portion of the computer code in the first template based on the received instruction.

9. The method of claim 7 further comprising determining, by the template builder, not to execute the instruction to modify the first template.

10. The method of claim 1 further comprising associating the computer code and the at least one candidate element with a second template.

11. The method of claim 1 further comprising:
identifying, by the analysis engine, a second candidate element of the hierarchical data structure for extraction;
automatically extracting, by an extraction engine, a second portion of the computer code associated with the second candidate element;
storing, by the extraction engine, the second portion of the computer code;
associating, by the extraction engine, the second portion of the computer code and the second candidate element with the first template;
receiving, by a template builder, a request for generation of a third document using the first template;
populating, by the template builder, a copy of the first template with the first portion and the second portion of the computer code; and
generating, by the template builder, the third document from the populated copy of the first template.

12. The method of claim 1 further comprising:
identifying, by the analysis engine, a second candidate element of the hierarchical data structure for extraction;
automatically extracting, by an extraction engine, a second portion of the computer code associated with the second candidate element;
storing, by the extraction engine, the second portion of the computer code;
associating, by the extraction engine, the second portion of the computer code and the second candidate element with a second template;
receiving, by a template builder, a request for generation of a third document using the second template;
populating, by the template builder, a copy of the second template with the second portion of the computer code; and
generating, by the template builder, the third document from the populated copy of the second template.

13. A method for extracting document elements for use in generating and populating a message template, the method comprising:
importing, by an analysis engine executing on a computing device, a first document including computer code;
generating, by the analysis engine, a hierarchical data structure including the computer code;
identifying, by the analysis engine, at least one candidate element of the hierarchical data structure for extraction;
generating, by an extraction engine executing on the computing device, a user interface displaying a visual rendering of the computer code associated with the at least one candidate element;
receiving, by the extraction engine, user interface input requesting extraction of the at least one candidate element;
extracting, by the extraction engine, a first portion of the computer code associated with the at least one candidate;
storing, by the extraction engine, the extracted first portion of the computer code;
associating, by the extraction engine, the extracted first portion of the computer code and the at least one candidate element with a template;
receiving, by a template builder, a request for generation of a second document using the template;
populating, by the template builder, a copy of the template with the extracted first portion of the computer code; and
generating, by the template builder, the second document from the populated copy of the template.
